(19) United States
(12) Patent Application Publication
(10) Pub. No.: US 2020/0231907 A1
(43) Pub. Date: Jul. 23, 2020

(54) Laundry Detergent Compositions For Eliminating, Reducing, And/Or Inhibiting Malodor

(71) Applicant: Henkel IP & Holding GmbH, Duesseldorf (DE)

(72) Inventor: Alma D. Calderon, Derby, CT (US)

(21) Appl. No.: 16/746,057

(22) Filed: Jan. 17, 2020

Related U.S. Application Data
(60) Provisional application No. 62/794,262, filed on Jan. 18, 2019.

(51) Int. Cl. C11D 3/38; C11D 17/06; C11D 17/04; C11D 3/00; C11D 1/83

(52) U.S. Cl. CPC C11D 3/38; C11D 17/06; C11D 1/72; C11D 3/0036; C11D 1/83; C11D 17/042

(57) ABSTRACT

A laundry detergent composition includes a detergent surfactant and saccharomyces ferment filtrate. The laundry detergent composition provides a benefit in the elimination, inhibition, and/or reduction of any malodor, for example dank malodor, body malodor, or food malodor.

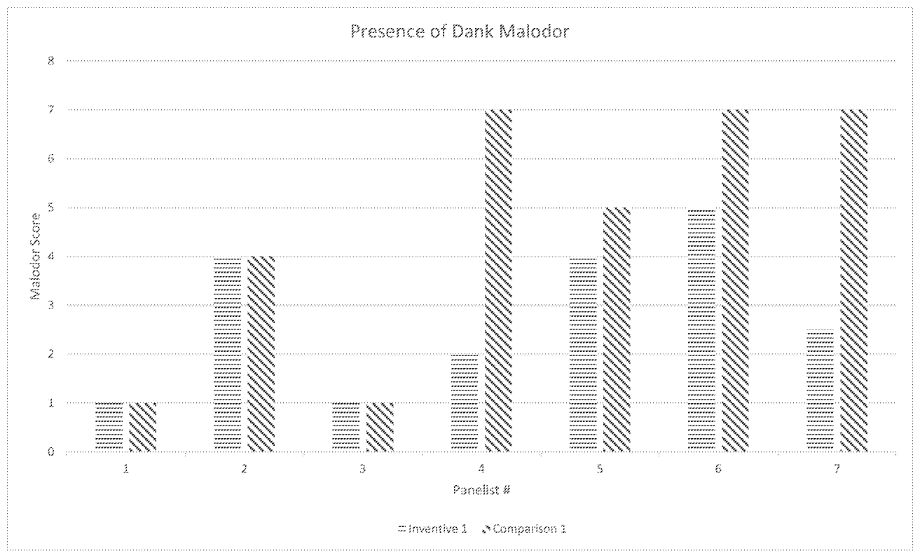

### FIELD OF THE INVENTION

The technical field relates to laundry detergent compositions. More particularly, the present disclosure relates to laundry detergent compositions that eliminate, reduce and/or inhibit the development of any malodor when laundry is washed, such as for example dank malodor when washed laundry is allowed to remain damp for a period of time, when laundry is exposed to a malodor, such as may originate for example from the wearer's body or from food.

### BACKGROUND OF THE INVENTION

Laundry detergent is a substance that can be added when one is washing fabrics to remove soils, stains, and other contaminants from the fabrics. Laundry detergent generally includes one or more surfactants, along with various additives. A surfactant is a substance which, when added to water, significantly reduces the surface tension of the water, allowing the water to penetrate the fabric rather than slide off its surface. The result is that the water can function more effectively, acting to loosen the soils and stains from the clothing, and then hold it until it can be washed away. The various additives used in laundry detergents may include anti-redeposition agents, corrosion inhibitors, fluorescent whitening agents, processing aids, colorants, fragrances, opacifiers, oxygen bleach, enzymes, fabric softening agents, chlorine scavengers, dye transfer inhibitors, and suds control agents, among others.

A particular function of a laundry detergent is the removal or inhibition of any malodor that may be present in the fabrics. Malodors may exist prior to washing, or they may develop after washing, under certain circumstances. Malodors prior to washing may come from any source that the fabrics have been exposed to, such as for example the wearer's body or from food that has been in proximity to the fabrics. Malodors after washing may develop due to inadequate drying. For example, once the fabrics have been washed with a laundry detergent as described above, the fabrics are typically dried to remove the residual moisture left from the washing process. Such drying may occur in a laundry drying machine, or by separating the fabrics from one another and exposing them to air, such as on a drying line. Sometimes, however, the washed fabrics may inadvertently be left in a condition that is not suitable for the removal of the residual moisture, such as in a washing machine, in a hamper, in a basket, or the like. When left in this damp condition for any length of time, such as several hours or more, the washed fabrics tend to develop a dank malodor, which overpowers any fragrances that may have been included in the laundry detergent. The development of this dank malodor is undesirable, and remains even if the fabrics are dried subsequently. As a result, the fabrics must be washed again to remove the dank malodor before they are suitable for ordinary use.

Accordingly, it is desirable to provide a laundry detergent that is capable of eliminating or inhibiting the development of any malodor, whether originating before or after washing. Moreover, it is desirable to provide a laundry detergent that is capable of inhibiting malodor in the event washed fabrics are inadvertently left in a damp condition for a period of time. Furthermore, other desirable features and characteristics will become apparent from the subsequent detailed description and the appended claims, taken in conjunction with the accompanying drawings and the foregoing technical field and background.

### BRIEF SUMMARY OF THE INVENTION

It has been discovered by the inventor herein that the inclusion of saccharomyces ferment filtrate into laundry detergents eliminates, inhibits, and/or reduces the development of malodor in fabrics. In one example, the inclusion of saccharomyces ferment filtrate into laundry detergents inhibits and/or reduces the development of dank malodor when fabrics that have been washed with such detergents are prevented from drying. This inhibition/reduction of dank malodor was beneficially observed over various time periods of damp fabric storage, including about 24 hours and about 48 hours. As such, the laundry detergents disclosed herein are useful for removing malodors from fabrics during washing and preventing the need to re-wash fabrics in the event that they are inadvertently left in a damp condition for a period of time. In another example, the inclusion of saccharomyces ferment filtrate into laundry detergents eliminates and/or reduces malodors originating prior to washing, such as for example from a wearer's body or from food that has been in proximity to the fabrics. This elimination reduction was observed after washing and drying of the fabrics. As such, the laundry detergents disclosed herein are useful for removing malodors from fabrics that originate prior to washing.

Accordingly, in one embodiment, disclosed herein is a laundry detergent composition that includes a detergent surfactant and saccharomyces ferment filtrate.

In another embodiment, disclosed herein is a laundry detergent composition that includes an ionic detergent surfactant in an amount of about 5% to about 55% by weight of the overall laundry detergent composition; a non-ionic detergent surfactant in an amount of about 5% to about 50% by weight of the overall laundry detergent composition; saccharomyces ferment filtrate in an amount of about 0.05% to about 2% by weight of the overall laundry detergent composition; and an additive comprising one or more of: additional enzymes, peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids, antimicrobial agents, and preservatives.

In yet another embodiment, disclosed herein is a laundry detergent composition that includes an ionic detergent surfactant in an amount of about 5% to about 55% by weight of the overall laundry detergent composition; a non-ionic detergent surfactant in an amount of about 5% to about 50% by weight of the overall laundry detergent composition; saccharomyces ferment filtrate in an amount of about 0.1% to about 1.5% by weight of the overall laundry detergent composition. The laundry detergent composition further includes an additive comprising one or more of: additional enzymes, peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids, antimicrobial agents, and preservatives. The laundry detergent is in the form of a liquid, a single dose pack, or a powdered solid.

This brief summary is provided to describe select concepts in a simplified form that are further described in the detailed description. This brief summary is not intended to identify key or essential features of the claimed subject matter, nor is it intended to be used as an aid in determining the scope of the claimed subject matter.

### BRIEF DESCRIPTION OF THE DRAWING

The present disclosure will hereinafter be described in conjunction with the Drawing FIGURE, which depicts a bar graph demonstrating the results of experimental testing in accordance with an embodiment of the present disclosure.

### DETAILED DESCRIPTION OF THE INVENTION

The following detailed description is merely exemplary in nature and is not intended to limit the single dose pack, or the method for producing or using the same. Furthermore, there is no intention to be bound by any theory presented in the preceding background or the following detailed description.

As used herein, the articles “a,” “an,” and “the” can be used herein to refer to one or to more than one (i.e., to at least one) of the grammatical object of the article, unless the language and/or context clearly indicates otherwise. By way of example, “an element” means one element or more than one element. Furthermore, as used herein, the term “about” as used in connection with a numerical value throughout the specification and the claims denotes an interval of accuracy, familiar and acceptable to a person skilled in the art. In general, such interval of accuracy is ±10%. Thus, “about ten” means 9 to 11. All numbers in this description indicating amounts, ratios of materials, physical properties of materials, and/or use are to be understood as modified by the word “about,” except as otherwise explicitly indicated. As an additional matter, all percentage amounts of the components of the laundry detergent composition are by weight percent of the overall composition, unless otherwise specified.

The present disclosure generally relates to laundry detergent compositions that are capable of eliminating, inhibiting, and/or reducing the development of any malodor in fabrics, whether originating prior to or after washing. In a particular embodiment, the present disclosure relates to laundry detergent compositions that are capable of inhibiting and/or reducing the development of dank malodor in washed, damp fabrics for a period of time. In another particular embodiment, the present disclosure relates to laundry detergent compositions that are capable or eliminating and/or reducing malodors on fabrics that originate prior to washing, such as from a wearer's body or from food to which the fabrics were exposed. The laundry detergent compositions of the present disclosure include saccharomyces ferment filtrate. As used herein, the term “laundry detergent” refers to any type of detergent (cleaning agent) that is added for cleaning laundry. “Detergent” is defined as any substance or preparation containing soaps and/or other surfactants intended for washing and cleaning processes. Thus, detergents are cleansing agents that can emulsify oils and hold dirt in suspension.

Laundry detergents with a malodor eliminating/inhibiting/reducing benefit as disclosed herein may be in any form (liquid, single dose pack, powder, paste, bar, cake, molded piece, shape, etc.). The form of laundry detergent generally depends on the composition and amount of solvent employed, among other factors. For example, liquid laundry detergents typically include anywhere from about 50% water to about 80% percent by weight water as solvent, such as from about 55% water to about 75% percent water, or from about 60% water to about 70% water. In another example, a single dose pack is formed by encapsulating a laundry detergent composition within a container, where the container includes a film. Single dose packs include anywhere from about 0% to about 40% by weight water as solvent, and about 0% to about 75% by weight non-aqueous solvent. For example, a single dose pack may include from about 5% to about 25% water, and about 5% to about 50% by weight non-aqueous solvent. Non-aqueous solvents include, for example, glycerol, propylene glycol, ethylene glycol, ethanol, and a 4C+ compounds, as known in the art. In yet another example, powder laundry detergents are formulated substantially free of water or non-aqueous solvents. As used herein, the phrase “substantially free” means that a given formulation is at least about 97 percent by weight free of the specified ingredient, and in certain embodiments as specified herein, at least about 98, at least about 99, at least about 99.9, or at least about 99.99 percent by weight free of the specified ingredient.

Regardless of the particular form of the laundry detergent, the compositions of the present disclosure include saccharomyces ferment filtrate for the purpose of eliminating, inhibiting, and/or reducing the any malodor in fabrics, for example inhibiting and/or reducing the development of dank malodor in washed, damp fabrics over a period of time, such as from about 1 hour to about 72 hours or more, or for example eliminating and/or reducing malodors originating from the exposure of fabrics to malodor sources prior to washing. saccharomyces ferment filtrate is a substance containing bacterial enzymes obtained by the fermentation and filtration of saccharomyces yeast. The bacterial enzymes are capable of utilizing inorganic nitrogen from, for example, ammonia, to form amino acids. saccharomyces ferment filtrate is an environmentally-friendly compound as it may be derived from organic feedstocks, such as vegetable feedstocks for example.

The above-described saccharomyces ferment filtrate may be provided as part of the laundry detergent composition in an amount of about 0.05 to about 10% by weight, such as about 0.05% to about 5% by weight, such as about 0.05% to about 2%, for example about 0.05% to about 1%, or from about 0.05% to about 0.7%. In other embodiments, the saccharomyces ferment filtrate may be present in an amount of about 0.1% to about 5% by weight, such as about 0.1% to about 2%, for example about 0.1% to about 1.5%, or from about 0.1% to about 0.7%. In particular embodiments, the saccharomyces ferment filtrate may be present in an amount from about 0.05% to about 0.2% by weight, from about 0.2% to about 0.4%, from about 0.4% to about 0.6%, or from about 0.6% to about 1%.

As initially noted above, the laundry detergent compositions of the present disclosure contain one or more detergent surfactants. For example, the laundry detergent composition may include an ionic detergent surfactant, where the ionic detergent surfactant is formulated for laundry in an exemplary embodiment. The ionic detergent surfactant may include one or more surfactants, including cationic and/or anionic surfactants, in various embodiments. The ionic detergent surfactant may be present in the laundry detergent composition at a concentration of from about 5 to about 55 weight percent in one embodiment, but the ionic detergent surfactant may be present in the laundry detergent composition at a concentration of about 10 to about 30 weight percent or from about 20 to about 25 weight percent in alternate embodiments, where weight percentages are based on a total weight of the laundry detergent composition.

Suitable ionic detergent surfactants that are anionic include soaps which contain sulfate or sulfonate groups, including those with alkali metal ions as cations. Usable soaps include alkali metal salts of saturated or unsaturated fatty acids with 12 to 18 carbon (C) atoms. Such fatty acids may also be used in incompletely neutralized form. Usable ionic detergent surfactants of the sulfate type include the salts of sulfuric acid semi esters of fatty alcohols with 12 to 18 C atoms, and/or alcohol ethoxysulfates. Usable ionic detergent surfactants of the sulfonate type include alkane sulfonates with 12 to 18 C atoms and olefin sulfonates with 12 to 18 C atoms, such as those that arise from the reaction of corresponding mono-olefins with sulfur trioxide, alpha-sulfofatty acid esters such as those that arise from the sulfonation of fatty acid methyl or ethyl esters, and lauryl ether sulfates.

Suitable ionic detergent surfactants that are cationic may include textile-softening substances of the general formula X, XI, or XII as illustrated below:

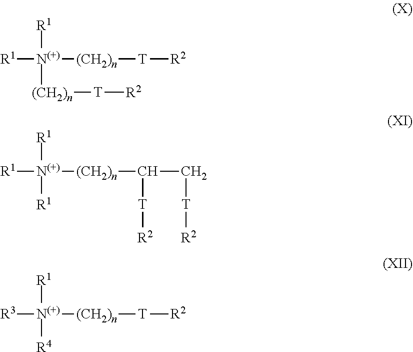

in which each R¹ group is mutually independently selected from among C₁₋₆ alkyl, alkenyl or hydroxyalkyl groups; each R² group is mutually independently selected from among C₈-₂₈ alkyl or alkenyl groups; R³=R¹ or (CH₂)ₙ-T-R²; R⁴=R¹¹ or R² or (CH₂)ₙ-T-R²; T=—CH₂—, —O—CO—, or —CO—O—, and n is an integer from 0 to 5. The ionic detergent surfactants that are cationic may include conventional anions of a nature and number required for charge balancing. Alternatively, the ionic detergent surfactant may include anionic detergent surfactants that may function to balance the charges with the cationic detergent surfactants. In some embodiments, ionic detergent surfactants that are cations may include hydroxyalkyltrialkylammonium compounds, such as C₁₂-₁₈ alkyl(hydroxyethyl)dimethyl ammonium compounds, and may include the halides thereof, such as chlorides or other halides. The ionic detergent surfactants that are cations may be especially useful for compositions intended for treating textiles.

In some embodiments, the anionic surfactant is a polyethoxylated alcohol sulfate, such as those sold under the trade name CALFOAM® 303 (Pilot Chemical Company, California). Such materials, also known as alkyl ether sulfates (AES) or alkyl polyethoxylate sulfates, are those which correspond to the following formula (XIII):

R′—O—(C2H4O)n—SO3M′ (XIII)

wherein R′ is a C₈-C₂₀ alkyl group, n is from 1 to 20, and M′ is a salt-forming cation, preferably, R′ is C₁₀-C₁₈ alkyl, n is from 1 to 15, and M′ is sodium, potassium, ammonium, alkylammonium, or alkanolammonium. In another embodiment, R′ is a C₁₂-C₁₆ alkyl, n is from 1 to 6 and M′ is sodium. In another embodiment, the alkyl ether sulfate is sodium lauryl ether sulphate (SLES).

In some embodiments, the anionic surfactant can be linear alkylbenzene sulfonic acid (LAS) or a salt thereof, alkyl ethoxylated sulphate, alkyl propoxy sulphate, alkyl sulphate, or a mixture thereof. Linear alkylbenzenesulfonate (LAS) is a water soluble salt of a linear alkyl benzene sulfonate having between 8 and 22 carbon atoms of the linear alkyl group. The salt can be an alkali metal salt, or an ammonium, alkylammonium, or alkanolammonium salt. In one embodiment, the LAS comprises an alkali metal salt of C₁₀-C₁₆ alkyl benzene sulfonic acids, such as C₁₁-C₁₄ alkyl benzene sulfonic acids.

Nonionic detergent surfactants may optionally be present in the laundry detergent composition at a concentration of from about 0 to about 60 weight percent, or from about 5 to about 50 weight percent, or from about 10 to about 30 weight percent, or from about 20 to about 40 weight percent in various embodiments. Suitable nonionic detergent surfactants include alkyl glycosides and ethoxylation and/or propoxylation products of alkyl glycosides or linear or branched alcohols in each case having 12 to 18 C atoms in the alkyl moiety and 3 to 20, or 4 to 10, alkyl ether groups. Corresponding ethoxylation and/or propoxylation products of N-alkylamines, vicinal diols, fatty acid esters and fatty acid amides, which correspond to the alkyl moiety in the stated long-chain alcohol derivatives, may furthermore be used. Alkylphenols having 5 to 12 C atoms may also be used in the alkyl moiety of the above described long-chain alcohol derivatives.

Examples of nonionic surfactants suitable for the present invention include, but are not limited to, polyalkoxylated alkanolamides, polyoxyalkylene alkyl ethers, polyoxyalkylene alkylphenyl ethers, polyoxyalkylene sorbitan fatty acid esters, polyoxyalkylene sorbitol fatty acid esters, polyoxyethylene polyoxypropylene alkyl ethers, polyoxyalkylene castor oils, polyoxyalkylene alkylamines, glycerol fatty acid esters, alkylglucosamides, alkylglucosides, alkylamine oxides, amine oxide surfactants, alkoxylated fatty alcohols, or a mixture thereof. In some embodiments, the nonionic surfactant is alcohol ethoxylate (AE), alcohol propoxylate, or a mixture thereof. In other embodiments, the nonionic surfactant is AE.

The AE may be primary and secondary alcohol ethoxylates, especially the C₈-C₂₀ aliphatic alcohols ethoxylated with an average of from 1 to 20 moles of ethylene oxide per mole of alcohol, and more especially the C₁₀-C₁₅ primary and secondary aliphatic alcohols ethoxylated with an average of from 1 to 10 moles, or from 3 to 8 moles of ethylene oxide per mole of alcohol.

Exemplary AEs are the condensation products of aliphatic C₈-C₂₀, preferably C₈-C₁₆, primary or secondary, linear or branched chain alcohols with ethylene oxide. In some embodiments, the alcohol ethoxylates contain 1 to 20, or 3 to 8 ethylene oxide groups, and may optionally be end-capped by a hydroxylated alkyl group.

In one embodiment, the AE has Formula (XIV):

R₂—(—O—C₂H₄—)ₘ—OH (XIV)

wherein R₂ is a hydrocarbyl group having 8 to 16 carbon atoms, 8 to 14 carbon atoms, 8 to 12 carbon atoms, or 8 to 10 carbon atoms; and m is from 1 to 20, or 3 to 8.

The hydrocarbyl group may be linear or branched, and saturated or unsaturated. In some embodiments, R₂ is a linear or branched C₈-C₁₆ alkyl or a linear group or branched C₈-C₁₆ alkenyl group. Preferably, R₂ is a linear or branched C₈-C₁₆ alkyl, C₈-C₁₄ alkyl, or C₈-C₁₀ alkyl group. In case (e.g., commercially available materials) where materials contain a range of carbon chain lengths, these carbon numbers represent an average. The alcohol may be derived from natural or synthetic feedstock. In one embodiment, the alcohol feedstock is coconut, containing predominantly C₁₂-C₁₄ alcohol, and oxo C12-C₁₅ alcohols.

Particularly for single-dose pack embodiments of the present disclosure, non-aqueous solvents may also be included, in the amounts as described above. Non-aqueous solvents that may be included are ethylene glycol, ethanol, and one or more 4C+ compounds. The term “4C+ compound” refers to one or more of: polyethylene glycol esters such as polyethylene glycol stearate, propylene glycol laurate, and/or propylene glycol palmitate; methyl ester ethoxylate; diethylene glycol; dipropylene glycol; sorbitol; tetramethylene glycol; butylene glycol; pentanediol; hexylene glycol; heptylene glycol; octylene glycol; 2-methyl, 1,3 propanediol; xylitol; mannitol; erythritol; dulcitol; inositol; adonitol; triethylene glycol; glycol ethers, such as ethylene glycol monobutyl ether, diethylene glycol monobutyl ether, triethylene glycol monobutyl ether, ethylene glycol monopropyl ether, diethylene glycol monoethyl ether, triethylene glycol monoethyl ether, diethylene glycol monomethyl ether, and triethylene glycol monomethyl ether; tris (2-hydroxyethyl)methyl ammonium methyl sulfate; ethylene oxide/propylene oxide copolymers with a number average molecular weight of 3,500 Daltons or less; and ethoxylated fatty acids.

Several other components may optionally be added to and included in the laundry detergent composition, including but not limited to additional enzymes (that is, enzymes in addition to those described above with regard to the saccharomyces ferment filtrate), peroxy compounds, bleach activators, anti-redeposition agents, neutralizers, optical brighteners, foam inhibitors, chelators, bittering agents, dye transfer inhibitors, soil release agents, water softeners, and other components. A partial, non-exclusive list of additional components (not illustrated) that may be added to and included in the laundry detergent composition include electrolytes, pH regulators, anti-graying agents, anti-crease components, bleach agents, colorants, scents, processing aids, antimicrobial agents, and preservatives.

Possible additional enzymes that may be in the laundry detergent composition contemplated herein include one or more of a protease, lipase, cutinase, amylase, carbohydrase, cellulase, pectinase, mannanase, arabinase, galactanase, xylanase, and/or peroxidase, but others are also possible. In general, the properties of the selected enzyme(s) should be compatible with the selected laundry detergent composition, (i.e., pH-optimum, compatibility with other enzymatic and non-enzymatic ingredients, etc.). The detergent additional enzyme(s) may be included in the laundry detergent composition by adding separate additives containing one or more enzymes, or by adding a combined additive comprising all the enzymes that are added to the laundry detergent composition. The enzyme(s) should be present in the laundry detergent composition in effective amounts, such as from about 0 weight percent to about 5 weight percent of enzyme, or from about 0.001 to about 1 weight percent, or from about 0.2 to about 2 weight percent, or from about 0.5 to about 1 weight percent, based on the total weight of the laundry detergent composition, in various embodiments.

As alluded to above, a peroxy compound may optionally be present in the laundry detergent composition. Exemplary peroxy compounds include organic peracids or peracidic salts of organic acids, such as phthalimidopercaproic acid, perbenzoic acid or salts of diperdodecanedioic acid, hydrogen peroxide and inorganic salts that release hydrogen peroxide under the washing conditions, such as perborate, percarbonate and/or persilicate. Hydrogen peroxide may also be produced with the assistance of an enzymatic system, i.e. an oxidase and its substrate. Other possible peroxy compounds include alkali metal percarbonates, alkali metal perborate monohydrates, alkali metal perborate tetrahydrates or hydrogen peroxide. Peroxy compounds may be present in the laundry detergent composition at an amount of from about 0 to about 50 weight percent, or an amount of from about 3 to about 30 weight percent, or an amount of from about 3 to about 10 weight percent, based on the total weight of the laundry detergent composition, in various embodiments.

Bleach activators may optionally be added and included in the laundry detergent composition. Conventional bleach activators that form peroxycarboxylic acid or peroxyimidic acids under perhydrolysis conditions and/or conventional bleach-activating transition metal complexes may be used. The bleach activator optionally present may include, but is not limited to, one or more of: N- or O-acyl compounds, for example polyacylated alkylenediamines, such as tetraacetylethylenediamine; acylated glycolurils, such as tetraacetylglycoluril; N-acylated hydantoins; hydrazides; triazoles; urazoles; diketopiperazines; sulfurylamides and cyanurates; carboxylic anhydrides, such as phthalic anhydride; carboxylic acid esters, such as sodium isononanoylphenolsulfonate; acylated sugar derivatives, such as pentaacetyl glucose; and cationic nitrile derivatives such as trimethylammonium acetonitrile salts.

To avoid interaction with peroxy compounds during storage, the bleach activators may be coated with shell substances or granulated prior to addition to the laundry detergent composition, in a known manner. As such, the bleach activator and/or other components may be present in a liquid laundry detergent composition as a free or floating particulate. Exemplary embodiments of the coating or shell substance include tetraacetylethylenediamine granulated with the assistance of carboxymethylcellulose and having an average grain size of 0.01 mm to 0.8 mm, granulated 1,5-diacetyl-2,4-dioxohexahydro-1,3,5-triazine, and/or trialkylammonium acetonitrile formulated in particulate form. In alternative embodiments, the bleach activators may be enclosed in a compartment, separate from the compartment that contains peroxy compounds and/or other compounds of the laundry detergent composition. In various embodiments, the bleach activators may be present in the laundry detergent composition in quantities of from about 0 to about 8 weight percent, or from about 0 to about 6 weight percent, or from about 0 to about 4 weight percent, in each case relative to the total weight of the laundry detergent composition.

One or more anti-redeposition agents may also be optionally included in the laundry detergent composition. Anti-redeposition agents include polymers with a soil detachment capacity, which are also known as “soil repellents” due to their ability to provide a soil-repelling finish on the treated surface, such as a fiber. Anti-redeposition agents include polymers with a soil detachment capacity. One example in regard to polyesters includes copolyesters prepared from dicarboxylic acids, such as adipic acid, phthalic acid or terephthalic acid. In an exemplary embodiment, an anti-redeposition agents includes polyesters with a soil detachment capacity that include those compounds which, in formal terms, are obtainable by esterifying two monomer moieties, the first monomer being a dicarboxylic acid HOOC—Ph—COOH and the second monomer a diol HO—(CHR¹¹—)aOH, which may also be present as a polymeric diol H—(O—(CHR¹¹—)ₐ)_{b}OH. Ph here means an ortho-, meta- or para-phenylene residue that may bear 1 to 4 substituents selected from alkyl residues with 1 to 22 C atoms, sulfonic acid groups, carboxyl groups and mixtures thereof. means hydrogen or an alkyl residue with 1 to 22 C atoms and mixtures thereof “a” means a number from 2 to 6 and “b” means a number from 1 to 300. The polyesters obtainable therefrom may contain not only monomer diol units —O—(CHR¹¹—)ₐO— but also polymer diol units —(O—(CHR¹¹—)ₐ)_{b}O—. The molar ratio of monomer diol units to polymer diol units may amount to from about 100:1 to about 1:100, or from about 10:1 to about 1:10 in another embodiment. In the polymer diol units, the degree of polymerization “b” may be in the range of from about 4 to about 200, or from about 12 to about 140 in an alternate embodiment. The average molecular weight of the polyesters with a soil detachment capacity may be in the range of from about 250 to about 100,000, or from about 500 to about 50,000 in an alternate embodiment. The acid on which the residue Ph is based may be selected from terephthalic acid, isophthalic acid, phthalic acid, trimellitic acid, mellitic acid, the isomers of sulfophthalic acid, sulfoisophthalic acid and sulfoterephthalic acid and mixtures thereof. Where the acid groups thereof are not part of the ester bond in the polymer, they may be present in salt form, such as an alkali metal or ammonium salt. Exemplary embodiments include sodium and potassium salts.

If desired, instead of the monomer HOOC—Ph—COOH, the polyester with a soil detachment capacity (the anti-redeposition agent) may include small proportions, such as no more than about 10 mole percent relative to the proportion of Ph with the above-stated meaning, of other acids that include at least two carboxyl groups. These include, for example, alkylene and alkenylene dicarboxylic acids such as malonic acid, succinic acid, fumaric acid, maleic acid, glutaric acid, adipic acid, pimelic acid, suberic acid, azelaic acid and sebacic acid. Exemplary diols HO—(CHR¹¹—)aOH include those in which R¹¹ is hydrogen and “a” is a number of from about 2 to about 6, and in another embodiment includes those in which “a” has the value of 2 and R¹¹ is selected from hydrogen and alkyl residues with 1 to 10 C atoms, or where R¹¹ is selected from hydrogen and alkyl residues with 1 to 3 C atoms in another embodiment. Examples of diol components are ethylene glycol, 1,2-propylene glycol, 1,3-propylene glycol, 1,4-butanediol, 1,5-pentane-diol, 1,6-hexanediol, 1,8-octanediol, 1,2-decanediol, 1,2-dodecanediol and neopentyl glycol. The polymeric diols include polyethylene glycol with an average molar mass in the range from about 1000 to about 6000. If desired, these polyesters may also be end group-terminated, with end groups that may be alkyl groups with 1 to 22 C atoms or esters of monocarboxylic acids. The end groups attached via ester bonds may be based on alkyl, alkenyl and aryl monocarboxylic acids with 5 to 32 C atoms, or with 5 to 18 C atoms in another embodiment. These include valeric acid, caproic acid, enanthic acid, caprylic acid, pelargonic acid, capric acid, undecanoic acid, undecenoic acid, lauric acid, lauroleic acid, tridecanoic acid, myristic acid, myristoleic acid, pentadecanoic acid, palmitic acid, stearic acid, petroselinic acid, petroselaidic acid, oleic acid, linoleic acid, linolaidic acid, linolenic acid, eleostearic acid, arachidic acid, gadoleic acid, arachidonic acid, behenic acid, erucic acid, brassidic acid, clupanodonic acid, lignoceric acid, cerotic acid, melissic acid, benzoic acid, which may bear 1 to 5 substituents having a total of up to 25 C atoms, or 1 to 12 C atoms in another embodiment, for example tert-butylbenzoic acid. The end groups may also be based on hydroxymonocarboxylic acids with 5 to 22 C atoms, which for example include hydroxyvaleric acid, hydroxycaproic acid, ricinoleic acid, the hydrogenation product thereof, hydroxystearic acid, and ortho-, meta- and para-hydroxybenzoic acid. The hydroxymonocarboxylic acids may in turn be joined to one another via their hydroxyl group and their carboxyl group and thus be repeatedly present in an end group. The number of hydroxymonocarboxylic acid units per end group, i.e. their degree of oligomerization, may be in the range of from 1 to 50, or in the range of from 1 to 10 in another embodiment. In an exemplary embodiment, polymers of ethylene terephthalate and polyethylene oxide terephthalate, in which the polyethylene glycol units have molar weights of from about 750 to about 5000 and the molar ratio of ethylene terephthalate to polyethylene oxide terephthalate of from about 50:50 to about 90:10, are used alone or in combination with cellulose derivatives. The anti-redeposition agent is present in the laundry detergent composition at an amount of from about 0 to about 3 weight percent, or an amount of from about 0 to about 2 weight percent, or an amount of from about 0 to about 1 weight percent, based on the total weight of the laundry detergent composition, in various embodiments.

Neutralizers are optionally added to and included in the laundry detergent composition. Exemplary neutralizers include, but are not limited to, sodium hydroxide, triethanol amine, monoethanol amine, buffers, or other compounds that adjusts the pH of the laundry detergent composition. Neutralizers may be present in the laundry detergent composition at an amount of from about 0 to about 5 weight percent in some embodiments, based on the total weight of the laundry detergent composition, but in other embodiments the neutralizer may be present in the laundry detergent composition at an amount of from about 0 to about 3 weight percent, or an amount of from about 0 to about 2 weight percent, based on the total weight of the laundry detergent composition.

Optical brighteners may optionally be included in the laundry detergent composition. Optical brighteners adsorb ultraviolet and/or violet light and re-transmit it as visible light, typically a visible blue light. Optical brighteners include, but are not limited to, derivatives of diaminostilbene disulfonic acid or the alkali metal salts thereof. Suitable compounds are, for example, salts of 4,4′-bis(2-anilino-4-morpholino-1,3,5-triazinyl-6-amino)stilbene 2,2′-disulfonic acid or compounds of similar structure which, instead of the morpholino group, bear a diethanolamino group, a methylamino group, an anilino group or a 2-methoxyethylamino group. Optical brighteners of the substituted diphenylstyryl type may furthermore be present, such as the alkali metal salts of 4,4′-bis(2-sulfostyryl)diphenyl, 4,4′-bis(4-chloro-3-sulfostyryl)diphenyl, or 4-(4-chlorostyryl)-4′-(2-sulfostyryl)diphenyl. Mixtures of the above-stated optical brighteners may also be used. Optical brighteners may be present in the laundry detergent composition at an amount of from about 0 to about 1 weight percent in some embodiments, but in other embodiments optical brighteners are present in an amount of from about 0.01 to about 0.5 weight percent, or an amount of from about 0.05 to about 0.3 weight percent, or an amount of from 0.005 to about 5 weight percent, based on the total weight of the laundry detergent composition.

Foam inhibitors may also optionally be included in the laundry detergent composition. Suitable foam inhibitors include, but are not limited to, soaps of natural or synthetic origin, which include an elevated proportion of Cis-C24 fatty acids. Suitable non-surfactant foam inhibitors are, for example, organopolysiloxanes and mixtures thereof with microfine, optionally silanized silica as well as paraffins, waxes, microcrystalline waxes and mixtures thereof with silanized silica or bis-fatty acid alkylenediamides. Mixtures of different foam inhibitors may also be used, for example mixtures of silicones, paraffins or waxes. In an exemplary embodiment, mixtures of paraffins and bistearylethylenediamide may be used. The laundry detergent composition may include the foam inhibitor at an amount of from about 0 to about 5 weight percent, but in other embodiments the foam inhibitor may be present at an amount of from about 0.05 to about 3 weight percent, or an amount of from about 0.5 to about 2 weight percent, based on the total weight of the laundry detergent composition.

Chelators bind and remove calcium, magnesium, or other metals from water, and may optionally be included in the laundry detergent composition. Many compounds can be used as water softeners, including but not limited to ethylenediaminetetraacetic acid (EDTA), nitrilotriacetic acid, diethylenetriaminepenta(methylenephosphonic acid), nitrilotris(methylenephosphonic acid), 1-hydroxyethane-1,1-diphosphonic acid, iminodisuccinic acid (IDS), or other chelating agents. Chelators may be present in the laundry detergent composition at an amount of from about 0 to about 5 weight percent in an exemplary embodiment, but in alternate embodiments the chelators are present at an amount of from about 0.01 to about 3 weight percent or an amount of from about 0.02 to about 1 weight percent, based on the total weight of the laundry detergent composition.

Bittering agents may optionally be added to hinder accidental ingestion of the single dose pack or the laundry detergent composition. Bittering agents are compositions that taste bad, so children or others are discouraged from accidental ingestion. Exemplary bittering agents include denatonium benzoate, aloin, and others. Bittering agents may be present in the laundry detergent composition at an amount of from about 0 to about 1 weight percent, or an amount of from about 0 to about 0.5 weight percent, or an amount of from about 0 to about 0.1 weight percent in various embodiments, based on the total weight of the laundry detergent composition.

The fabrics and/or garments subjected to a washing, cleaning or textile care processes contemplated herein may be conventional washable laundry, such as household laundry. In some embodiments, the major part of the laundry is garments and fabrics, including but not limited to knits, woven fabrics, denims, non-woven fabrics, felts, yarns, and toweling. The fabrics may be cellulose based such as natural cellulosics, including cotton, flax, linen, jute, ramie, sisal or coir or manmade cellulosics (e.g., originating from wood pulp) including viscose/rayon, ramie, cellulose acetate fibers (tricell), lyocell or blends thereof. The fabrics may also be non-cellulose based such as natural polyamides including wool, camel, cashmere, mohair, rabbit, and silk, or the fabric may be a synthetic polymer such as nylon, aramid, polyester, acrylic, polypropylene and spandex/elastin, or blends of any of the above-mentioned products. Examples of blends are blends of cotton and/or rayon/viscose with one or more companion material such as wool, synthetic fibers (e.g., polyamide fibers, acrylic fibers, polyester fibers, polyvinyl alcohol fibers, polyvinyl chloride fibers, polyurethane fibers, polyurea fibers, aramid fibers), and cellulose-containing fibers (e.g., rayon/viscose, ramie, flax, linen, jute, cellulose acetate fibers, lyocell).

In one embodiment, the fabrics and/or garments are added to a washing machine, and the laundry detergent is also added to the washing machine before wash water is added. The fabrics and/or garments are laundered with the wash water and the laundry detergent. The fabrics and/or garments may then be dried and processed as normal. The laundry detergent is effective in removing any malodors that may be been present in the laundry, such as for example as may have originated from a wearer's body or from food to which the fabrics were exposed.

In another embodiment, if, however, a period of time elapses before the drying process, the laundry detergent of the present disclosure is suitable for inhibiting and/or reducing the development of dank malodor in the fabrics and/or garments during such period of time.

### ILLUSTRATIVE EXAMPLES

The present disclosure is now illustrated by the following non-limiting examples. It should be noted that various changes and modifications can be applied to the following examples and processes without departing from the scope of this disclosure, which is defined in the appended claims. Therefore, it should be noted that the following examples should be interpreted as illustrative only and not limiting in any sense.

Four different liquid laundry detergent compositions were prepared according to the foregoing description, three of which included various amounts of the saccharomyces ferment filtrate as described above (“Inventive 1”, “Inventive 2”, and “Inventive 3”), whereas the fourth was provided as a comparative composition (“Comparative 1”) and included none of the saccharomyces ferment filtrate. Thus, the four laundry detergent compositions differ primarily in the amount of the saccharomyces ferment filtrate used (very minor differences in the amount of water account for the difference in the amount of saccharomyces ferment filtrate such that all examples total to 100%). TABLE 1, below, sets forth these four compositions in terms of weight percent of the ingredients:

TABLE 1

| | Comparative | Inventive | Inventive | Inventive |
|---|---|---|---|---|
| Ingredient | 1 | 1 | 2 | 3 |
| Water | q.s. | q.s. | q.s. | q.s. |
| Citric Acid | 4-10 | 4-10 | 4-10 | 4-10 |
| Caustic Soda | 1-7 | 1-7 | 1-7 | 1-7 |
| Triethanolamine | 0.5-3.5 | 0.5-3.5 | 0.5-3.5 | 0.5-3.5 |
| Alkylbenzenesulfonic | 0.1-6 | 0.1-6 | 0.1-6 | 0.1-6 |
| Acid | | | | |
| Coconut Oil Fatty | 0.1-2.5 | 0.1-2.5 | 0.1-2.5 | 0.1-2.5 |
| Acid | | | | |
| C12-C15 Alcohol | 2.5-11 | 2.5-11 | 2.5-11 | 2.5-11 |
| Ethoxylate | | | | |
| C12-C15 3- | 2.5-11 | 2.5-11 | 2.5-11 | 2.5-11 |
| Ethoxysulfate | | | | |
| Dye | 0.01-0.3 | 0.01-0.3 | 0.01-0.3 | 0.01-0.3 |
| Calcium Chloride | 0.01-1 | 0.01-1 | 0.01-1 | 0.01-1 |
| Anti-Graying Agent | 0.01-2.5 | 0.01-2.5 | 0.01-2.5 | 0.01-2.5 |
| Anti-Redeposition | 0.01-2.5 | 0.01-2.5 | 0.01-2.5 | 0.01-2.5 |
| Agent | | | | |
| Chelating Agent | 0.01-2.5 | 0.01-2.5 | 0.01-2.5 | 0.01-2.5 |
| Preservative | 0.01-3 | 0.01-3 | 0.01-3 | 0.01-3 |
| Protease | 0.1-5 | 0.1-5 | 0.1-5 | 0.1-5 |
| Mannanase | 0.1-5 | 0.1-5 | 0.1-5 | 0.1-5 |
| Saccharomyces | 0 | 0.13 | 0.37 | 0.50 |
| Ferment | | | | |
| Filtrate | | | | |
| Total | 100 | 100 | 100 | 100 |

### Example 1

Laundry detergent compositions were prepared according to the foregoing three inventive compositions and one comparative composition. Several top-loading and front-loading washing machines were provided. Several terry clothes were inserted into each machine. Then, each machine was provided with a respective one of the four laundry detergents. The terry clothes were washed in the machines. Then, the washed, damp terry clothes were placed individually into mason jars with holes punched into the lids. The terry clothes in the mason jars were allowed to sit for a period of time, some for about 24 hours and some for about 48 hours. After the period of time elapsed, seven trained panelists evaluated the presence of dank malodor in each terry cloth on a scale of 0 to 10 (10 being the most malodorous).

The Drawing FIGURE presents a bar graph showing the panelists' assessment of the presence of dank malodor for Inventive 3 (0.50% saccharomyces ferment filtrate) versus Comparative 1 (no saccharomyces ferment filtrate), wherein the left bar for each panelist is Inventive 1 and the right bar for each panelist is Comparative 1. As shown, each of panelists 4-7 observed less malodor in the terry clothes that had been washed in the Inventive 3 detergent. The average difference among these panelists was about 3 points on the scale of 0 to 10.

### Example 2

The testing was repeated with another panel of 9 for Inventive 3 at 24 hours and another panel of 10 for Inventive 3 at 48 hours, using both top-loading and front-loading washing machines. Each such test was performed twice. TABLE 2, below, shows the results of this additional testing, with the number of panelists indicating whether Comparative 1 was best (least malodorous) or Inventive 3 was best, or whether there was parity between the samples, along with the average difference in score (0 to 10) among the panelists. As can be seen, the terry clothes washed with a detergent in accordance with Inventive 3 were determined to be best regardless of the type of washing machine (front-loading or top-loading) and regardless of the time period (24 or 48 hours).

TABLE 2

| | Comparative | Inventive | | Average |
|---|---|---|---|---|
| | 1 | 3 | | Point |
| Test Description | Best | Best | Parity | Difference |
| Top-loader, 24 hours #1 | 3 | 6 | 0 | 1.2 |
| Top-loader, 24 hours #2 | 0 | 7 | 2 | 1.8 |
| Front-loader, 24 hours #1 | 1 | 7 | 1 | 1.3 |
| Front-loader, 24 hours #2 | 0 | 9 | 0 | 3.8 |
| Top-loader, 48 hours #1 | 0 | 10 | 0 | 2.3 |
| Top-loader, 48 hours #2 | 0 | 7 | 3 | 2.4 |
| Front-loader, 48 hours #1 | 3 | 5 | 2 | 1 |
| Front-loader, 48 hours #2 | 0 | 10 | 0 | 2.9 |

### Example 3

The testing was repeated with another panel of 7 for Inventive 1 and Inventive 2 at 48 hours, using both top-loading and front-loading washing machines. TABLE 3, below, shows the results of this additional testing, with the number of panelists indicating whether Comparative 1 was best (least malodorous) or Inventive 1 or Inventive 2 was best, or whether there was parity between the samples, along with the average difference in score (0 to 10) among the panelists. As can be seen, the terry clothes washed with a detergent in accordance with Inventive 1 or Inventive 2 were determined to be best regardless of the type of washing machine (front-loading or top-loading) and regardless of the level of ferment filtrate included.

TABLE 3

| | | | | | Average |
|---|---|---|---|---|---|
| Test | Comparative | Inventive 1 | Inventive 2 | | Point |
| Description | 1 Best | Best | Best | Parity | Difference |
| Top-loader, | 2 | 5 | N/A | 0 | 1.1 |
| Example 1 | | | | | |
| Top-loader, | 1 | N/A | 5 | 1 | 2.1 |
| Example 2 | | | | | |
| Front-loader, | 1 | 5 | N/A | 1 | 1.8 |
| Example 1 | | | | | |
| Front-loader, | 2 | N/A | 5 | 0 | 1 |
| Example 2 | | | | | |

### Example 4

Three different liquid laundry detergent compositions were prepared according to the foregoing description, two of which included various amounts of the saccharomyces ferment filtrate as described above (“Inventive 4” and “Inventive 5”), whereas the third was provided as a comparative composition (“Comparative 2”) and included none of the saccharomyces ferment filtrate. These three detergent compositions were prepared on the basis of Inventive 1, Inventive 2, and Comparative 1, except that total surfactant content was in the range of 20%-30% by weight, and the amount of ferment filtrate was 0.5%, 1.0%, and 0% by weight, respectively. Thus, the three laundry detergent compositions differ primarily in the amount of the saccharomyces ferment filtrate used (very minor differences in the amount of water account for the difference in the amount of saccharomyces ferment filtrate such that all examples total to 100%).

Towels were exposed to a synthetic body malodor compound, which is a compound intended to represent the odor of body malodor for testing and evaluation purposes. The fabrics were placed into a high-efficiency front-loading washing machine, and then subsequently dried. 18 panelists were asked to assess which of the towels, those washed with Comparative 2 or Inventive 4, had the most malodor remaining after washing and drying. 67% of the panelists indicated that Comparative 2 had more malodor whereas 33% of the panelists indicated that Inventive 4 had more malodor. Accordingly, this example shows a statistically significant reduction in malodor for the Inventive 4 composition including the saccharomyces ferment filtrate.

### Example 5

Towels were exposed to the synthetic body malodor, as described above. The fabrics were placed into a high-efficiency front-loading washing machine, and then subsequently dried. 18 panelists were asked to assess which of the towels, those washed with Comparative 2 or Inventive 5, had the most malodor remaining after washing and drying. The panelists were also asked to rate the intensity of the malodor detected in each, on a scale of 1 to 10. 52% of the panelists indicated that Comparative 2 had more malodor with an average intensity of 3.53 whereas 23% of the panelists indicated that Inventive 5 had more malodor with an average intensity of 1.07 (25% of the panelist indicated no difference between the two). This test was repeated for a second time: in the second test, 56% of the panelists indicated that Comparative 2 had more malodor with an average intensity of 4.41 whereas 33% of the panelists indicated that Inventive 5 had more malodor with an average intensity of 3.89 (11% of the panelist indicated no difference between the two). Accordingly, this example shows a statistically significant reduction in malodor for the Inventive 5 composition including the saccharomyces ferment filtrate, along with a reduction in intensity of the malodor.

### Example 6

Laundry detergent compositions were prepared according to the Inventive 5 composition and the Comparative 2 composition. Several front-loading washing machines were provided. Several terry clothes were inserted into the machines. Then, each machine was provided with a respective one of the two laundry detergents. The terry clothes were washed in the machines. Then, the washed, damp terry clothes were placed individually into mason jars with holes punched into the lids. The terry clothes in the mason jars were allowed to sit for a period of about 24 hours. After the period of time elapsed, 18 trained panelists evaluated the presence of dank malodor in each terry cloth on a scale of 0 to 10 (10 being the most malodorous). The average malodor score of Comparative 2 was 2.93 and the average malodor score of Inventive 5 was 0.83. Accordingly, this example shows a statistically significant reduction in dank malodor for the Inventive 5 composition including the saccharomyces ferment filtrate.

### Example 7

In accordance with further examples of the present disclosure, two different single-dose pack laundry detergent compositions were prepared according to the foregoing description, one of which included 1% by weight of the saccharomyces ferment filtrate as described above (“Inventive 6”), whereas the second was provided as a comparative composition (“Comparative 3”) and included none of the saccharomyces ferment filtrate. Thus, the two laundry detergent compositions differ primarily in the amount of the saccharomyces ferment filtrate used (very minor differences in the amount of water account for the difference in the amount of saccharomyces ferment filtrate such that both compositions total to 100%). TABLE 4, below, sets forth these two compositions in terms of weight percent of the ingredients:

TABLE 4

| Ingredient | Comparative 3 | Inventive 6 |
|---|---|---|
| C12-15 Alcohol Ethoxylate | 19-30 | 19-30 |
| Optical Brightener | 0.01-0.8 | 0.01-0.8 |
| Propylene Glycol | 5-11 | 5-11 |
| Minimum Water | 0-5 | 0-5 |
| Sodium Sulfite | 0.5-3 | 0.5-3 |
| Glycerin | 9-15 | 9-15 |
| Soil Release Polymer | 1-10 | 1-10 |
| Bittering Agent | 0.01-0.2 | 0.01-0.2 |
| Coconut Fatty Acid | 5-20 | 5-20 |
| Optical Brightener | 0.01-0.8 | 0.01-0.8 |
| Alcohol Ethoxysulfate | 15-35 | 15-35 |
| Monethanolamine | 0.5-5 | 0.5-5 |
| Linear Alkylbenzene Sulphonic Acid | 2-9 | 2-9 |
| Protease | 0.02-1.5 | 0.02-1.5 |
| Mannanase | 0.02-1.5 | 0.02-1.5 |
| Amylase | 0.02-1.5 | 0.02-1.5 |
| Saccharomyces Ferment Filtrate | 0 | 0.5-2.5 |
| Total | 100.000 | 100.000 |

Towels were exposed to the synthetic body malodor, as described above. The fabrics were placed into a high-efficiency front-loading washing machine, and then subsequently dried. 15 panelists were asked to assess which of the towels, those washed with Comparative 3 or Inventive 6, had the most malodor remaining after washing and drying. 69% of the panelists indicated that Comparative 3 had more malodor whereas 31% of the panelists indicated that Inventive 6 had more malodor. Accordingly, this example shows a statistically significant reduction in malodor for the Inventive 6 composition including the saccharomyces ferment filtrate.

Accordingly, the present disclosure has provided laundry detergent compositions that incorporate saccharomyces ferment filtrate for the purposes of eliminating, inhibiting, and/or reducing any malodor in fabrics, for example dank malodor when fabrics that have been washed with such detergents are prevented from drying or for example odors that originate prior to washing, such as those originating from a wearer's body or from food with which the fabrics have come in contact. The inhibition/reduction of dank malodor was beneficially observed over various time periods of damp fabric storage, including about 24 hours and about 48 hours. As such, the laundry detergent compositions disclosed herein are useful for eliminating malodors from fabrics being washed and further for preventing the need to re-wash fabrics in the event that they are inadvertently left in a damp condition for a period of time. The elimination/reduction in pre-washing malodors was beneficially observed after washing and drying of the fabrics. As such, the laundry detergent compositions disclosed herein are further useful for obtaining improved removal of malodors during washing.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A laundry detergent composition comprising:
a detergent surfactant; and
saccharomyces ferment filtrate.

2. The laundry detergent composition of claim 1, wherein the saccharomyces ferment filtrate is present in an amount of about 0.05% to about 10% by weight of the overall laundry detergent composition.

3. The laundry detergent composition of claim 2, wherein the saccharomyces ferment filtrate is present in an amount of about 0.1% to about 2% by weight of the overall laundry detergent composition.

4. The laundry detergent composition of claim 1, wherein the laundry detergent is in the form of a liquid, a single dose pack, or a powdered solid.

5. The laundry detergent composition of claim 4, wherein the laundry detergent is in the form of the liquid, and further comprises from about 50% water to about 80% percent water, by weight of the overall laundry detergent composition.

6. The laundry detergent composition of claim 4, wherein the laundry detergent is in the form of the single dose pack, and further comprises from about 0% to about 40% water and about 0% to about 75% non-aqueous solvent, by weight of the overall laundry detergent composition.

7. The laundry detergent composition of claim 4, wherein the laundry detergent is in the form of the powdered solid, and is substantially free of water and non-aqueous solvents.

8. The laundry detergent composition of claim 1, wherein the detergent surfactant comprises an ionic surfactant that is present in an amount of about 5% to about 55% by weight of the overall laundry detergent composition.

9. The laundry detergent composition of claim 1, wherein the detergent surfactant comprises a non-ionic surfactant that is present in an amount of about 5% to about 50% by weight of the overall laundry detergent composition.

10. The laundry composition of claim 1, further comprising an additive comprising one or more of: additional enzymes, peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids, antimicrobial agents, and preservatives.

11. A laundry detergent composition comprising:
an ionic detergent surfactant in an amount of about 5% to about 55% by weight of the overall laundry detergent composition;
a non-ionic detergent surfactant in an amount of about 5% to about 50% by weight of the overall laundry detergent composition;
saccharomyces ferment filtrate in an amount of about 0.05% to about 2% by weight of the overall laundry detergent composition; and
an additive comprising one or more of: additional enzymes, peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids, antimicrobial agents, and preservatives.

12. The laundry detergent composition of claim 11, wherein the saccharomyces ferment filtrate is present in an amount of about 0.1% to about 0.7% by weight of the overall laundry detergent composition.

13. The laundry detergent composition of claim 11, wherein the laundry detergent is in the form of a liquid, a single dose pack, or a powdered solid.

14. The laundry detergent composition of claim 11, wherein the laundry detergent is in the form of the liquid, and further comprises from about 50% water to about 80% percent water, by weight of the overall laundry detergent composition.

15. The laundry detergent composition of claim 11, wherein the laundry detergent is in the form of the single dose pack, and further comprises from about 0% to about 40% water and about 0% to about 75% non-aqueous solvent, by weight of the overall laundry detergent composition.

16. The laundry detergent composition of claim 11, wherein the laundry detergent is in the form of the powdered solid, and is substantially free of water and non-aqueous solvents.

17. A laundry detergent composition comprising:
an ionic detergent surfactant in an amount of about 5% to about 55% by weight of the overall laundry detergent composition;
a non-ionic detergent surfactant in an amount of about 5% to about 50% by weight of the overall laundry detergent composition;
saccharomyces ferment filtrate in an amount of about 0.1% to about 1.5% by weight of the overall laundry detergent composition; and
an additive comprising one or more of: additional enzymes, peroxy compounds, bleach activators, anti-redeposition agents, neutralizers, optical brighteners, foam inhibitors, chelators, bittering agents, dye transfer inhibitors, soil release agents, water softeners, electrolytes, pH regulators, anti-graying agents, anti-crease components, bleach agents, colorants, scents, processing aids, antimicrobial agents, and preservatives,
wherein the laundry detergent is in the form of a liquid, a single dose pack, or a powdered solid.

18. The laundry detergent composition of claim 17, wherein the laundry detergent is in the form of the liquid, and further comprises from about 50% water to about 80% percent water, by weight of the overall laundry detergent composition.

19. The laundry detergent composition of claim 17, wherein the laundry detergent is in the form of the single dose pack, and further comprises from about 0% to about 40% water and about 0% to about 75% non-aqueous solvent, by weight of the overall laundry detergent composition.

20. The laundry detergent composition of claim 17, wherein the laundry detergent is in the form of the powdered solid, and is substantially free of water and non-aqueous solvents.
